(19) United States
(12) Patent Application Publication
(10) Pub. No.: US 2024/0341282 A1
(43) Pub. Date: Oct. 17, 2024

(54) DOMESTICATED FOWL HEALTH MONITORING SYSTEM AND METHOD

(71) Applicant: iCHASE Co., Ltd., Taipei (TW)

(72) Inventors: KUANG-FU CHANG, Taipei (TW); LI-WAN HUANG, Taipei (TW); CHIA-JUNG CHANG, Taipei (TW)

(21) Appl. No.: 18/701,443

(22) PCT Filed: Oct. 11, 2022
(86) PCT No.: PCT/CN2022/124676

§ 371 Date: Apr. 15, 2024

(30) Foreign Application Priority Data
Oct. 15, 2021 (CN) 202111203859.9

(51) Int. Cl. A01K 29/00; G01G 17/08; G01G 19/414

(52) U.S. Cl. CPC A01K 29/005; G01G 17/08; G01G 19/414

(57) ABSTRACT

A domesticated fowl health monitoring system includes a learning calibration module, a computing core, a cloud module, and a monitoring module. The learning calibration module is configured to detect a weight of at least one first domesticated fowl and generate a first domesticated fowl image. The computing core is configured to analyze a number of the at least one first domesticated fowl and generate a domesticated fowl image feature and an image-to-weight formula. The cloud module is configured to store the domesticated fowl image feature and the image-to-weight formula. The monitoring module is configured to generate a second domesticated fowl image presenting at least one second domesticated fowl. The cloud module is further configured to obtain a unit weight of the at least one second domesticated fowl based on the second domesticated fowl image and the image-to-weight formula. The present disclosure further provides a domesticated fowl health monitoring method.

### CROSS-REFERENCE TO RELATED APPLICATION(S)

This application is the National Stage Application of International Patent Application No. PCT/CN2022/124676, filed on Oct. 11, 2022, which claims the benefit of and priority to China Patent Application No. 202111203859.9, filed on Oct. 15, 2021, the contents of all which are hereby incorporated herein fully by reference into the present disclosure for all purposes.

### FIELD

The present disclosure relates to a health monitoring system and a health monitoring method, and more particularly, to a domesticated fowl health monitoring system and a domesticated fowl health monitoring method that can automatically perform calibration and monitoring to save manpower.

### BACKGROUND

Chickens among domesticated fowls and pigs among domesticated animals have always been the main source of protein in our daily diet, and not only do they contain high nutritional value but they are also the main raw materials for many processed foods. In recent years, the economic output of Taiwan's chicken commodity has reached NT$39.1 billion, accounting for 23.92% of Taiwan's total animal husbandry output value, so the chicken commodity is an important domestic agricultural product. The health condition of chickens is often closely related to the eating behavior of chickens. At present, the detection of the eating behavior in domesticated fowl houses is mainly done manually. However, the number of chickens in domesticated fowl houses is enormous, so traditional management methods are quite time-consuming and labor-intensive, and relying on the domesticated fowl owner's experience may lead to problems in cost control and quality control.

However, during domesticated fowl breeding, irreparable losses may occur often due to factors such as limitations in the number, scope or response speed of monitoring devices. Particularly, in tropical and subtropical regions, heat stress has become one of the most challenging problems for domesticated fowl owners due to hot weather in the summer. Heat stress reduces the growth rate of domesticated fowls, adversely affects egg quality, and has even been associated with sudden mass death of domesticated fowls. According to early breeding experience, it was found that heat stress is the key related to stability of domesticated fowl growth and egg quality. Usually, heat stress is evaluated using the temperature humidity index (THI), that is, heat stress is evaluated by measuring temperature and humidity at the same time. However, temperature and humidity index are indirect indicators, and the standard of heat stress may also differ depending on the chicken breed, the chicken's diet and drinking water supply, which may easily lead to incorrect evaluation on heat stress or growth conditions, resulting in losses in domesticated fowl breeding.

Furthermore, general domesticated fowl owners understand well that the health condition of a domesticated fowl is closely related to the weight and the activity of the domesticated fowl. If the weight of the domesticated fowl is insufficient or the space or the time given for its activity is insufficient during a breeding process and a growth process, the health condition of the domesticated fowl will be seriously affected. Traditionally, in order to solve this problem, a solution usually requires a lot of manpower to measure the weight of individual domesticated fowl, conduct on-site observations and evaluations on the health condition of each domesticated fowl, and record activity and activity time of each domesticated fowl. As a result, not only does this problem often consume a lot of manpower and time, but also cannot improve the processing speed, thus resulting in technical problems, such as difficulty in reducing breeding and maintenance costs of domesticated fowl owners and poor monitoring efficiency.

Therefore, there is room for improvement on designing a domesticated fowl health monitoring system and a domesticated fowl health monitoring method to solve the aforementioned technical problems.

### SUMMARY

The objective of the present disclosure is to provide a domesticated fowl health monitoring system and a domesticated fowl health monitoring method that can solve the technical problems, such as difficulty in reducing breeding and maintenance costs and poor monitoring efficiency, existing in the prior art, and achieve the objectives of low maintenance costs, rapid response, and full-time monitoring.

In order to achieve the aforementioned objective, the domesticated fowl health monitoring system provided by the present disclosure includes: a learning calibration module, a computing core, a cloud module, a learning calibration module and a monitoring module. The learning calibration module includes a weighing structure and a first camera, wherein the weighing structure is configured to detect a weight value of at least one first domesticated fowl on the weighing structure, and the first camera is arranged in the weighing structure and configured to generate a first domesticated fowl image of the at least one first domesticated fowl on the weighing structure. The computing core is coupled to the learning calibration module and configured to receive the weight value and the first domesticated fowl image to analyze a number of the at least one first domesticated fowl in the first domesticated fowl image and generate at least one domesticated fowl image feature and an image-to-weight formula corresponding to each of the at least one domesticated fowl image feature. The cloud module is coupled to the computing core and configured to store the at least one domesticated fowl image feature and the image-to-weight formula. The monitoring module is coupled to the cloud module and includes a second camera, wherein the second camera is configured to generate a second domesticated fowl image presenting at least one second domesticated fowl. The cloud module is further configured to obtain a unit weight of the at least one second domesticated fowl based on the second domesticated fowl image and the image-to-weight formula.

Further, in the domesticated fowl health monitoring system of the present disclosure, the unit weight of the at least one second domesticated fowl is obtained further based on the at least one domesticated fowl image feature.

Further, the domesticated fowl health monitoring system according to the present disclosure further includes an early warning analysis module. The early warning analysis module is coupled to the cloud module, and the early warning analysis module is configured to output at least one of a statistical report and a warning message based on at least one of the unit weight and an activity value.

Further, the domesticated fowl health monitoring system of the present disclosure further includes a mobile communication platform. The mobile communication platform is wirelessly coupled to the early warning analysis module and is configured to receive at least one of the statistical report and the warning message.

Further, in the domesticated fowl health monitoring system of the present disclosure, the mobile communication platform includes one of a workstation, a server, a desktop computer, a notebook computer, a tablet computer, a personal digital assistant or a smart phone.

Further, in the domesticated fowl health monitoring system of the present disclosure, the computing core includes a deep learning architecture that uses an object detection algorithm tool for the computing core to identify a target object. The object detection algorithm tool is used for deep learning or image processing. The cloud module is further configured to compare, through at least one convolution layer and at least one pooling layer, whether the second domesticated fowl image matches each of the at least one domesticated fowl image feature and obtain the unit weight and the activity value.

Further, in the domesticated fowl health monitoring system of the present disclosure, the cloud module includes a server and a cloud database, wherein the server is configured to obtain at least one of the unit weight and the activity value. The cloud database is coupled to the server and configured to store at least one of the at least one domesticated fowl image feature, the image-to-weight formula, the unit weight, and the activity value.

Further, in the domesticated fowl health monitoring system of the present disclosure, the server is coupled to the cloud database through one of narrowband internet of things (NB-IoT), LoRa WAN, LTE and Wi-Fi.

Further, in the domesticated fowl health monitoring system of the present disclosure, the weighing structure includes a weighing platform and an intermediate platform. The weighing platform is configured to accommodate the at least one first domesticated fowl, the intermediate platform is arranged above the weighing platform, and the first camera is arranged under the intermediate platform.

Further, in the domesticated fowl health monitoring system of the present disclosure, the weighing platform is coupled to the intermediate platform through at least two column bodies.

In addition, the domesticated fowl health monitoring method provided by the present disclosure includes: detecting a weight value of at least one first domesticated fowl; generating a first domesticated fowl image of the at least one first domesticated fowl; analyzing a number of the at least one first domesticated fowl in the first domesticated fowl image and generating at least one domesticated fowl image feature and an image-to-weight formula corresponding to each of the at least one domesticated fowl image feature; storing the at least one domesticated fowl image feature and the image-to-weight formula; generating a second domesticated fowl image presenting at least one second domesticated fowl; and obtaining a unit weight of the at least one second domesticated fowl based on the second domesticated fowl image, the at least one domesticated fowl image feature, and the image-to-weight formula.

Further, in the domesticated fowl health monitoring method of the present disclosure, the unit weight of the at least one second domesticated fowl is obtained further based on the at least one domesticated fowl image feature.

Further, the domesticated fowl health monitoring method of the present disclosure further includes outputting at least one of a statistical report and a warning message based on at least one of the unit weight and an activity value.

When the domesticated fowl health monitoring system and the domesticated fowl health monitoring method of the present disclosure are utilized, the cloud module of the domesticated fowl health monitoring system may pre-store a weight judgment database. Firstly, the learning calibration module performs a machine learning (ML) process of an artificial intelligence (AI) model; the weighing structure of the learning calibration module detects a weight value of the at least one domesticated fowl on the weighing structure; and the first camera generates the first domesticated fowl image of the at least one domesticated fowl on the weighing structure. Afterwards, the computing core receives from the learning calibration module the weight value and the first domesticated fowl image to analyze a number of the at least one domesticated fowl in the first domesticated fowl image and to generate the at least one domesticated fowl image feature and the image-to-weight formula to be stored in the cloud module, thereby completing the machine learning process. As a result, the cloud module stores at least one domesticated fowl image feature and the image-to-weight formula. With respect to the foregoing steps, it is performed sequentially or simultaneously that the monitoring module generates through the second camera the second domesticated fowl image corresponding to at least one of the at least one domesticated fowl. Finally, the cloud module may obtain the unit weight of the at least one domesticated fowl based on the second domesticated fowl image, the at least one domesticated fowl image feature, and the image-to-weight formula. Alternatively, the cloud module may obtain the activity value of each of the at least one domesticated fowl based on the second domesticated fowl image and the at least one domesticated fowl image feature. Further, the learning calibration module may continuously and repeatedly perform operations of the machine learning process over time so as to continuously calibrate the at least one domesticated fowl image feature and the image-to-weight formula stored in the cloud module, thereby making the domesticated fowl health monitoring system of the present disclosure more sensitive and accurate. Since the above-mentioned learning, monitoring and calibration operations do not require intervention of redundant manpower and can operate unattended full time without any human supervision, it not only saves labor costs but is not limited by time, thereby making domesticated fowl breeding and maintenance more efficient.

Therefore, the domesticated fowl health monitoring system and method of the present disclosure can solve the technical problems, such as difficulty in reducing breeding and maintenance costs and poor monitoring efficiency, existing in the prior art, and achieve the objectives of low maintenance costs, rapid response, and full-time monitoring.

In order to further understand the technology, means and functions adopted by the present disclosure to achieve the expected objective, please refer to the following detailed description and accompanying drawings of the present disclosure, so that it is believed that a deep and specific understanding of the present disclosure can be obtained accordingly. However, it should be noted that the accompanying drawings are only for reference and illustration but not intended to limit the present disclosure.

### BRIEF DESCRIPTION OF THE DRAWINGS

FIG. 1 is a schematic architecture diagram of a domesticated fowl health monitoring system according to a first embodiment of the present disclosure.

FIG. 2 is another schematic configuration diagram of the domesticated fowl health monitoring system according to the first embodiment of the present disclosure.

FIG. 3 is a schematic architecture diagram of the domesticated fowl health monitoring system according to a second embodiment of the present disclosure.

FIG. 4 is a flow chart of a domesticated fowl health monitoring method of the present disclosure.

### DETAILED DESCRIPTION

The implementation of the present disclosure is described below through specific embodiments. Those skilled in the art can easily understand other advantages and functions of the present disclosure from the content disclosed in the present specification. The present disclosure may also be implemented or applied through other different specific embodiments, and various details in the present specification of the present disclosure can also be modified and amended in various ways based on different viewpoints and applications without departing from the spirit of the present disclosure.

It should be noted that the structure, proportion, size, number of components, etc. shown in the accompanying drawings of the present specification are only used to correspond to the content disclosed in the present specification for those familiar with this technology to understand and read but not intended to limit the implementation of the present disclosure, so they are not technically significant. Any modifications in structure, changes in proportion or adjustments in size shall fall within the scope covered by the technical content disclosed in the present disclosure under a condition without affecting the functions that may be produced and the objectives that may be achieved by the present disclosure.

The technical content and detailed description of the present disclosure will be described below with reference to the drawings.

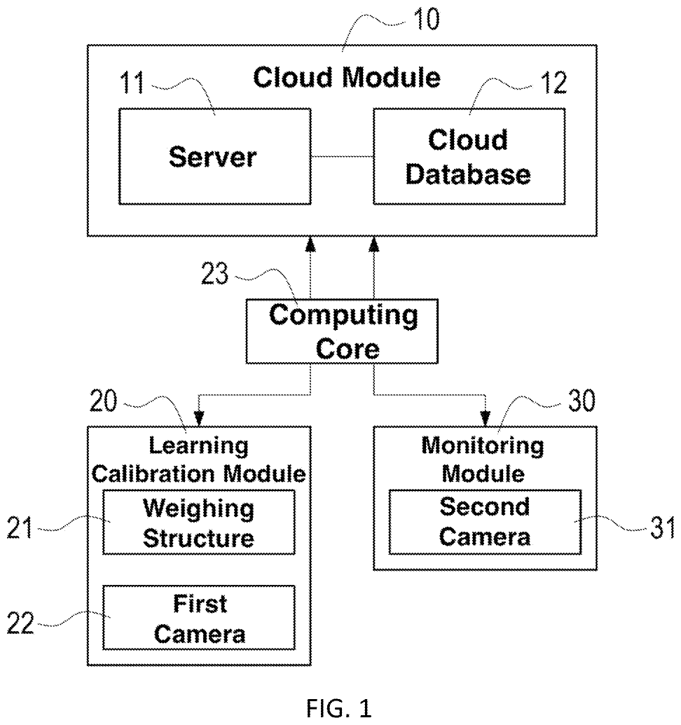

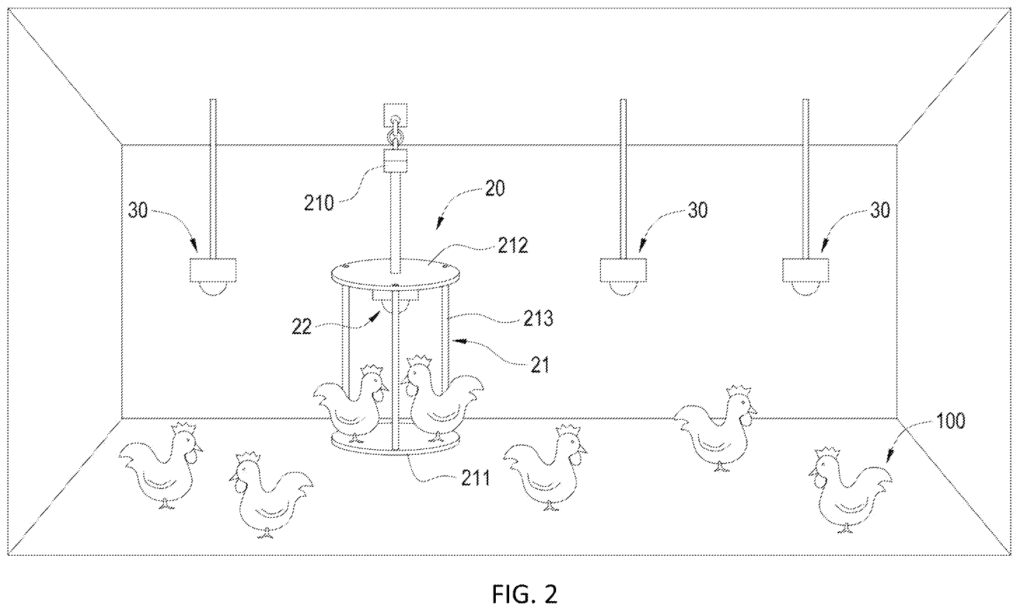

Please refer to FIG. 1 to FIG. 2. FIG. 1 is a schematic architecture diagram of a first embodiment of a domesticated fowl health monitoring system of the present disclosure. FIG. 2 is a schematic configuration diagram of the first embodiment of the domesticated fowl health monitoring system of the present disclosure. In the first embodiment of the present disclosure, the domesticated fowl health monitoring system provided by the present disclosure includes: a cloud module 10, a computing core 23, a learning calibration module 20 and a monitoring module 30. The cloud module 10 is configured to store at least one domesticated fowl image feature and an image-to-weight formula corresponding to each of the at least one domesticated fowl image feature. In the first embodiment of the present disclosure, the cloud module 10 includes a server 11 and a cloud database 12. The server 11 is configured to obtain at least one of a unit weight of each of domesticated fowls (i.e., the individual weight of any chicken 100, as shown in FIG. 2) and an activity value of each of the domesticated fowls. Further, the cloud database 12 is coupled to the server 11 and is configured to store at least one of the at least one domesticated fowl image feature, the image-to-weight formula, the unit weight, and the activity value. Furthermore, the server 11 is coupled to the cloud database 12 through one of narrowband internet of things (NB-IoT), LoRa WAN, LTE and Wi-Fi. The computing core 23 is coupled to the cloud module 10.

The learning calibration module 20 is coupled to the computing core 23 and the cloud module 10, and the learning calibration module 20 includes a weighing structure 21 and a first camera 22. The weighing structure 21 is configured to detect a weight value of at least one domesticated fowl (at least one chicken 100, as shown in FIG. 2) on the weighing structure. The first camera 22 is arranged in the weighing structure 21 and is configured to generate a first domesticated fowl image of the at least one domesticated fowl on the weighing structure 21. The computing core 23 may be arranged in the weighing structure 21. The computing core 23 receives the weight value and the first domesticated fowl image to analyze a number of the at least one domesticated fowl that is shown in the first domesticated fowl image and to generate the at least one domesticated fowl image feature and the image-to-weight formula. In the first embodiment of the present disclosure, the weighing structure 21 includes a weighting sensor 210, a weighing platform 211 and an intermediate platform 212. The weighing platform 211 is configured to accommodate at least one domesticated fowl. The intermediate platform 212 is arranged above the weighing platform 211, and the first camera 22 is arranged under the intermediate platform 212 for photographing at least one chicken 100 from above. The weighing platform 211 is coupled to the intermediate platform 212 through at least two column bodies 213, so that the weighing platform 211 and the intermediate platform 212 interact with each other. In the first embodiment of the present disclosure, the computing core 23 includes a deep learning architecture that uses an object detection algorithm tool for the computing core 23 to identify a target object. The object detection algorithm tool is used for deep learning or image processing, for example, a mask region-based convolutional neural networks (mask R-CNN) including at least one convolution layer and at least one pooling layer. The cloud module 10 is configured to compare, through at least one convolution layer and at least one pooling layer, whether the first domesticated fowl image matches each of the at least one domesticated fowl image feature and obtain, based on the image-to-weight formula, the unit weight (i.e., the individual weight of any chicken 100) or obtain an activity value or a uniformity value. As shown in FIG. 2, the first camera 22 may capture a top-view image of at least one chicken 100 (for example, two chickens as shown in FIG. 2), and transmit the image to the computing core 23, so that the computing core 23 may calculate a number of chickens on the weighing platform 211. The weighing platform 211 transmits the total weight of the chickens thereon to the computing core 23, so that the computing core 23 may calculate the average weight of the chickens on the weighing platform 211. According to an embodiment of the present disclosure, if the computing core 23 determines that there is only one chicken on the weighing platform 211, then the computing core 23 may establish a corresponding relationship, i.e., an image-to-weight formula, between a top-view image feature (such as a length, a top-view area or the like of a chicken) and a weight. However, the above implementation does not limit the scope of the present application. For example, the computing core 23 may also calculate an average value of the top-view image feature (e.g., an average length) and an average value of the weight of the chickens on the weighing platform 211 and may also establish an image-to-weight formula.

According to an embodiment of the present disclosure, the computing core 23 may also determine whether the chicken is moving based on a relationship between an image of a single chicken and time. For example, if the computing core 23 determines that an image of a chicken is stationary or does not move beyond a predetermined range (e.g., a movement distance less than 1 meter) within a predetermined time (e.g., ten minutes), then the computer core may determine that the chicken is not active enough. The computing core 23 may use the image of the first camera 22 and the image of a second camera 31 and determine a proportion of chickens that are not active enough. If the proportion of chickens that are not active enough exceeds a threshold, the chickens may have infectious diseases in a chicken farm, and the computing core 23 may issue a warning notification.

Furthermore, an evaluation result of a confusion matrix based on machine learning of the learning calibration module 20 in the present disclosure for red feather native chickens is as follows:

| Chicken Number | Actually Positive | Actually Negative |
|---|---|---|
| Predicted Positive | TP = 197 | FP = 18 |
| Predicted Negative | FN = 13 | TN |

Accuracy = TP/(TP + FP) = 91.6%
Recall Rate = TP/(TP + FN) = 93.8%

A true positive (TP) means that the number of chicken counted manually is “yes” and counted by deep learning counting is “yes”, while a false positive (FP) means that the number counted manually is “no” and counted by deep learning counting is “yes”. A false negative (FN) means that the number counted manually is “yes” and counted by deep learning counting is “no”, while a true negative (TN) means that the number counted manually is “no” and counted by deep learning counting is “no”. The aforementioned result was obtained by using a machine learning counting manner and a manual counting manner, respectively, during a three-month breeding period. As shown above, the machine learning counting of the present disclosure may replace manual counting to effectively evaluate an average weight of chickens. Data of multiple average weights collected everyday were further converted into daily standard deviations. Whether in an experimental result for red feather roosters or in an experimental result for red feather hens, it can be observed that the daily standard deviation of the average weight of chickens becomes greater in a later breeding stage. It is inferred that the larger daily standard deviation may be caused by adult chickens being more likely to fight than young chickens, so chickens that are weaker are unable to compete with stronger chickens for food during feeding, resulting in significant size differences among chickens. It can be seen that the standard deviation of the average weight can help monitor the overall health condition of the chickens. If the standard deviation of the average weight is becoming greater, different zones for breeding may be considered to stabilize the average weight of the chickens.

The monitoring module 30 is coupled to the cloud module 10, and the monitoring module 30 includes a second camera 31. Further, the monitoring module 30 may use the previously established image-to-weight formula to quickly determine whether the weight of the chicken is abnormal. The second camera 31 is configured to generate a second domesticated fowl image presenting at least one domesticated fowl (which may be any other chicken 100 outside the weighing structure 21 in FIG. 2). Alternatively, the cloud module 10 obtains the activity value of each of the at least one domesticated fowl based on the second domesticated fowl image and the at least one domesticated fowl image feature. Furthermore, judgment conditions, such as an activity distance, an activity frequency and a stationary period of each chicken 100 presented in the second domesticated fowl image, may be the bases, for the cloud module 10, to determine the activity value. For example, if the activity distance is short and the activity frequency is low, the activity of the chicken 100 is determined to be poor, and a threshold may be further set to classify groups.

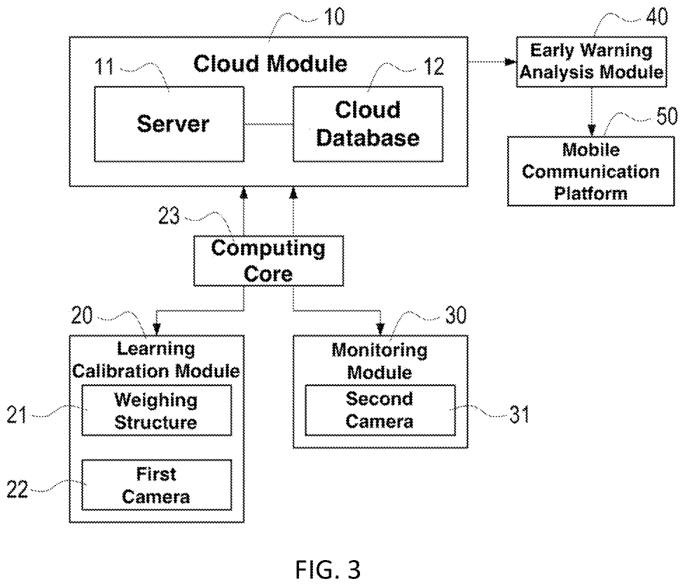

FIG. 3 is a schematic architecture diagram of a second embodiment of a domesticated fowl health monitoring system of the present disclosure. The second embodiment of the domesticated fowl health monitoring system of the present disclosure is substantially the same as the first embodiment but further includes an early warning analysis module 40 and a mobile communication platform 50. The early warning analysis module 40 is coupled to the cloud module 10, and the early warning analysis module 40 is configured to output at least one of a statistical report and a warning message based on at least one of a unit weight and an activity value. The mobile communication platform 50 is wirelessly coupled to the early warning analysis module 40 and receives at least one of the statistical report and the warning message, so that a domesticated fowl owner may predict the health condition of the chickens 100 or the growth trend of the chickens 100 in advance and respond in advance or take preventive measures in advance to reduce the risks and costs of breeding domesticated fowls. In the second embodiment of the present disclosure, the mobile communication platform 50 includes one of a workstation, a server, a desktop computer, a notebook computer, a tablet computer, a personal digital assistant or a smart phone. However, the present disclosure is not limited to the examples above.

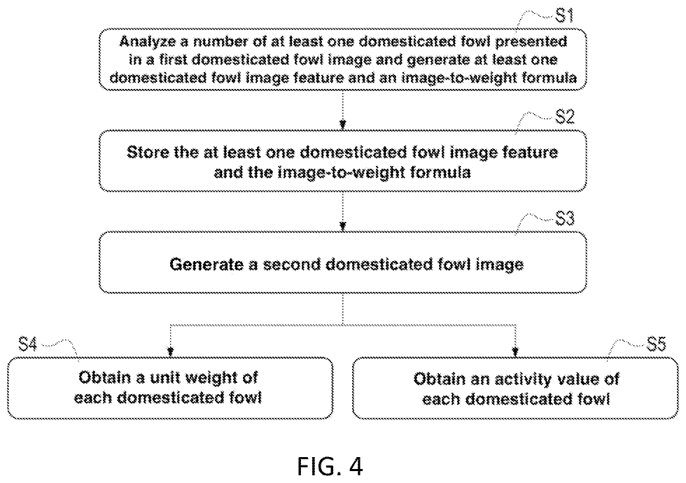

In FIG. 4, a flow chart of a domesticated fowl health monitoring method of the present disclosure is provided. First, the learning calibration module 20 performs a machine learning (ML) process of an artificial intelligence (AI) model. The weighing structure 21 of the learning calibration module 20 detects a weight value of at least one domesticated fowl on the weighing structure 21, and the first camera 22 generates a first domesticated fowl image of the at least one domesticated fowl on the weighing structure 21. Afterwards, the computing core 23 receives, from the learning calibration module 20, the weight value and the first domesticated fowl image to analyze a number of the at least one domesticated fowl presented in the first domesticated fowl image and to generate at least one domesticated fowl image feature and an image-to-weight formula that are to be stored in the cloud module (Step S1), thus completing the machine learning process. As a result, the cloud module 10 stores the at least one domesticated fowl image feature and the image-to-weight formula (Step S2). With respect to the foregoing steps, the monitoring module 30 sequentially or simultaneously generates, through the second camera 31, a second domesticated fowl image corresponding to at least one of the at least one domesticated fowl (Step S3). Finally, the cloud module 10 may obtain a unit weight of each of the at least one domesticated fowl based on the second domesticated fowl image, the at least one domesticated fowl image feature, and the image-to-weight formula (Step S4). Alternatively, the cloud module 10 may obtain an activity value of each of the at least one domesticated fowl based on the second domesticated fowl image and the at least one domesticated fowl image feature (Step S5). Further, the learning calibration module 20 may continuously and repeatedly perform operations of the machine learning process over time so as to continuously calibrate the at least one domesticated fowl image feature and the image-to-weight formula stored in the cloud module 10, thus making the domesticated fowl health monitoring system of the present disclosure more sensitive and accurate. Since the above-mentioned learning, monitoring and calibration operations of the present disclosure do not require intervention of redundant manpower, may operate unattended full time, and without any human supervision, not only do the above-mentioned operations save labor costs but are also not limited by time, thus making domesticated fowl breeding and maintenance more efficient.

Therefore, the domesticated fowl health monitoring system of the present disclosure can solve the technical problems, such as difficulty in reducing breeding and maintenance costs and poor monitoring efficiency, existing in the prior art, and achieve the objectives of low maintenance costs, rapid response, and full-time monitoring.

The above are only detailed descriptions and drawings of preferred embodiments of the present disclosure. However, the features of the present disclosure are not limited thereto and not used to limit the present disclosure. All claimed scopes of the present disclosure shall be determined by the following claims. All embodiments that fall within the spirit of claims of the present disclosure and similar modified embodiments thereof shall be included in the scopes of the present disclosure. Any changes or modifications that can be easily thought of by any person skilled in the art in the field of the present disclosure can be covered by the following claims of the present application.

What is claimed is:

1. A domesticated fowl health monitoring system, comprising:
a learning calibration module including a weighing structure and a first camera, wherein the weighing structure is configured to detect a weight value of at least one first domesticated fowl on the weighing structure, and the first camera is arranged in the weighing structure and configured to generate a first domesticated fowl image of the at least one first domesticated fowl on the weighing structure;
a computing core coupled to the learning calibration module and configured to receive the weight value and the first domesticated fowl image to analyze a number of the at least one first domesticated fowl in the first domesticated fowl image and generate at least one domesticated fowl image feature and an image-to-weight formula corresponding to each of the at least one domesticated fowl image feature, wherein the image-to-weight formula includes a relative relationship between an image feature value and a weight;
a cloud module coupled to the computing core and configured to store the at least one domesticated fowl image feature and the image-to-weight formula; and
a monitoring module coupled to the cloud module and including a second camera, wherein the second camera is configured to generate a second domesticated fowl image presenting at least one second domesticated fowl,
wherein the cloud module is further configured to obtain a unit weight of the at least one second domesticated fowl based on the second domesticated fowl image and the image-to-weight formula.

2. The domesticated fowl health monitoring system of claim 1, wherein the unit weight of the at least one second domesticated fowl is obtained further based on the at least one domesticated fowl image feature.

3. The domesticated fowl health monitoring system of claim 1, further including an early warning analysis module coupled to the cloud module, wherein the early warning analysis module is configured to output at least one of a statistical report and a warning message based on at least one of the unit weight and an activity value.

4. The domesticated fowl health monitoring system of claim 3, further including a mobile communication platform wirelessly coupled to the early warning analysis module and configured to receive at least one of the statistical report and the warning message.

5. The domesticated fowl health monitoring system of claim 4, wherein the mobile communication platform includes one of a workstation, a server, a desktop computer, a notebook computer, a tablet computer, a personal digital assistant or a smart phone.

6. The domesticated fowl health monitoring system of claim 1, wherein the computing core comprises a deep learning architecture that uses an object detection algorithm tool for the computing core to identify a target object, and the cloud module is further configured to compare, through at least one convolution layer and at least one pooling layer, whether the second domesticated fowl image matches each of the at least one domesticated fowl image feature and obtain the unit weight and the activity value.

7. The domesticated fowl health monitoring system of claim 1, wherein the cloud module includes a server and a cloud database, the server is configured to obtain at least one of the unit weight and the activity value, and the cloud database is coupled to the server and configured to store at least one of the at least one domesticated fowl image feature, the image-to-weight formula, the unit weight, and the activity value.

8. The domesticated fowl health monitoring system of claim 7, wherein the server is coupled to the cloud database through one of narrowband internet of things (NB-IoT), LoRa WAN, LTE and Wi-Fi.

9. The domesticated fowl health monitoring system of claim 1, wherein the weighing structure includes a weighing platform and an intermediate platform, the weighing platform is configured to accommodate the at least one first domesticated fowl, the intermediate platform is arranged above the weighing platform, and the first camera is arranged under the intermediate platform.

10. The domesticated fowl health monitoring system of claim 9, wherein the weighing platform is coupled to the intermediate platform through at least two column bodies.

11. A domesticated fowl health monitoring method, comprising:
detecting a weight value of at least one first domesticated fowl;
generating a first domesticated fowl image of the at least one first domesticated fowl;
analyzing a number of the at least one first domesticated fowl in the first domesticated fowl image and generating at least one domesticated fowl image feature and an image-to-weight formula corresponding to each of the at least one domesticated fowl image feature;
storing the at least one domesticated fowl image feature and the image-to-weight formula;
generating a second domesticated fowl image presenting at least one second domesticated fowl; and
obtaining a unit weight of the at least one second domesticated fowl based on the second domesticated fowl image and the image-to-weight formula.

12. The domesticated fowl health monitoring method of claim 11, wherein the unit weight of the at least one second domesticated fowl is obtained further based on the at least one domesticated fowl image feature.

13. The domesticated fowl health monitoring method of claim 11, wherein the image-to-weight formula includes a relative relationship between an image feature value and a weight.

14. The domesticated fowl health monitoring method of claim 11, further comprising:
outputting at least one of a statistical report and a warning message based on at least one of the unit weight and an activity value.
